(19) United States
(12) Patent Application Publication
(10) Pub. No.: US 2012/0306653 A1
(43) Pub. Date: Dec. 6, 2012

(54) MEDICAL SENSOR

(75) Inventors: Torsten MUSIOL, Ratingen (DE); David William LEWIS, Atlanta, GA (US); Marcos Ulises TONG ALVAREZ, Espoo (FI); Ole REINARTZ, Neuss (DE); Remberto MARTINEZ GONZALEZ, Pinsio (FI); Vreddhi BHAT, Bangalore, Karnataka (IN)

(73) Assignee: NOKIA SIEMENS NETWORKS OY, Espoo (FI)

(21) Appl. No.: 13/151,399

(22) Filed: Jun. 2, 2011

(51) Int. Cl. G06F 15/16; G08B 23/00

(52) U.S. Cl. 340/573.1; 709/219

(57) ABSTRACT

The invention provides a medical monitoring device connected to a server (typically cloud based) via a mobile network with a mobile phone acting as a gateway. The system enables medical data to be collected over a long period of time in a system in which each of the elements can be optimized.

The present invention is related to the collection and use of medical sensors.

Medical sensors that are worn by patients are well known. A problem exists in that the use of medical sensors usually requires the use of medical professionals and medical premises in order to take and interpret measurements from such sensors.

In addition to the cost of facilities and medical professionals, the collection of data in such a manner is inconvenient for both users and medical staff.

Accordingly, there is a need for a more flexible system for recording and interpreting data obtained from medical sensors.

The present invention seeks to address at least some of the problems outlined above.

The present invention provides a mobile communication device comprising a first input configured to receive medical data of a user of the mobile communication device and a first output configured to provide said medical data to a server (typically a remote server) via a mobile communications link.

The first output may be configured to periodically provide said medical data to the server via the mobile communications link, wherein a time period between successive provisions of medical data to said server is variable.

A second input may be provided for receiving an indication from the server of a desired period between successive provisions of medical data to said server. For example, a doctor interacting with the server may control the rate of provision of the medical data. Alternatively, or in addition, a third input may be provided for receiving an indication from the user of a desired period between successive provisions of medical data to said server. An algorithm may be required for handling conflicts between rates of provision of data set by the server and set by the user.

The invention may include one or more of a first mode, a second mode and a third mode. In the first mode (if used), the time period between successive provisions of medical data to said server may be equal to or greater than one day. In the second mode (if used), the time period between successive provisions of medical data to said server may be less than one hour (e.g. one minute). In the third mode (if used), the time period between successive provisions of electrocardiography data to said server is zero (such that the data transmission is continuous).

In some forms of the invention, the time period between successive provisions of medical data to said server may be at least partially dependent on the power level of the mobile communication device.

The mobile communication device may also comprise a fourth input configured to receive additional data from said user; and a second output configured to provide said medical data and said additional data to the server via the mobile communications link. A user interface may be provided to enable the user to provide said additional data. The additional data may include one or more pre-defined comments. Alternatively, or in addition, the additional data may include free text provided by the first user/patient.

An emergency input (e.g. in the form of an emergency input key) may be provided to enable the user to use the additional data to indicate an emergency event.

The medical data and the additional data may be stored with timestamp data such that the time of generation of the medical data can be compared with the time of generation of the additional data.

The present invention also provides a method comprising receiving medical data of a user at a first input of a mobile communication device and providing said medical data from the mobile communication device to a server via a mobile communications link.

In some forms of the invention, a time period between successive provisions of medical data to said server is variable. The period between successive provisions of medical data may be at least partially set by the server. Alternatively, or in addition, the period between successive provisions of medical data may be at least partially set by the user.

The invention may further comprise receiving additional data from said user at a second input of the mobile communication device and providing said medical data and said additional data to a server via the mobile communications link. The additional data may include an indication of an emergency event. The additional data may be provided using a user interface of the mobile communication device.

In some forms of the invention, the medical data and the additional data are stored with timestamp data such that the time of generation of the medical data can be compared with the time of generation of the additional data.

The present invention also provides an apparatus (e.g. a server) comprising: a first input configured to receive medical data from a mobile communication device via a mobile communications link, wherein the medical data relates to a user of said mobile communication device; and a processor for processing said medical data.

A first output may be provided for indicating to the mobile communication device a desired period between successive provisions of the medical data.

A second input may be provided for indicating a desired period between successive provisions of the medical data. For example, a doctor interacting with the server may control the rate of provision of the medical data.

The apparatus may include a second output configured to provide an alert in the event that one of a number of defined anomalies are detected in said medical data. The alert may be provided to the said user. Alternatively, or in addition, the alert may be provided to a second user (such as a paramedic, a caregiver or a relative defined by the first user/patient). In some forms of the invention, the alert may include data relating to the location of the mobile communication device (e.g. obtained by determining the location of the mobile communication device).

The present invention further provides a method comprising: receiving medical data from a mobile communication device via a mobile communication link, wherein the medical data relates to a user of said mobile communication device; and processing said medical data.

The invention may include indicating to the mobile communication device a desired time period between successive provisions of medical data.

The invention may include receiving an indication of the desired period between successive provisions of the medical data.

In some forms of the invention, an alert is provided in the event that one of a number of defined anomalies are detected in said medical data. The alert may be provided to the said user. Alternatively, or in addition, the alert may be provided to a second user. The alert may include data relating to the location of the mobile communication device.

The present invention further provides a computer program comprising code (or some other means) for receiving medical data of a user at a first input of a mobile communication device and code (or some other means) for providing said medical data from the mobile communication device to a server via a mobile communications link. The computer program may additionally include any of the other features discussed above. The computer program may be a computer program product comprising a computer-readable medium bearing computer program code embodied therein for use with a computer.

The present invention yet further provides a computer program comprising code (or some other means) for receiving medical data from a mobile communication device via a mobile communication link, wherein the medical data relates to a user of said mobile communication device. The computer program may additional comprise code (or some other means) for processing said medical data. The computer program may additionally include any of the other features discussed above. The computer program may be a computer program product comprising a computer-readable medium bearing computer program code embodied therein for use with a computer.

Exemplary embodiments of the invention are described below, by way of example only, with reference to the following numbered drawings.

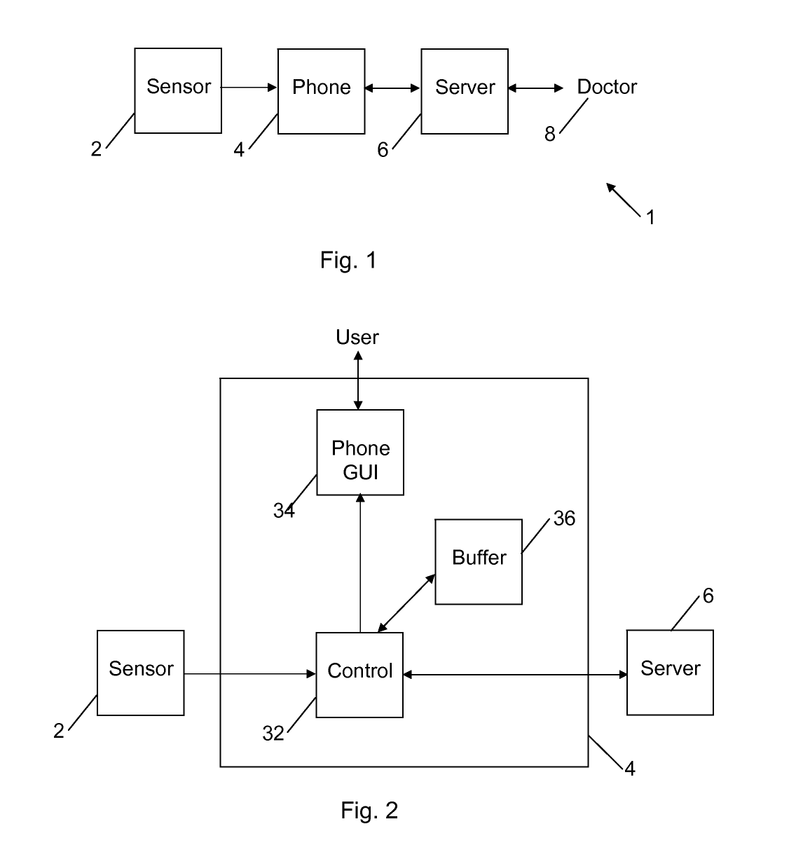

FIG. 1 is a block diagram of a system in accordance with an aspect of the present invention;

FIG. 2 is a block diagram showing further details of the system of FIG. 1;

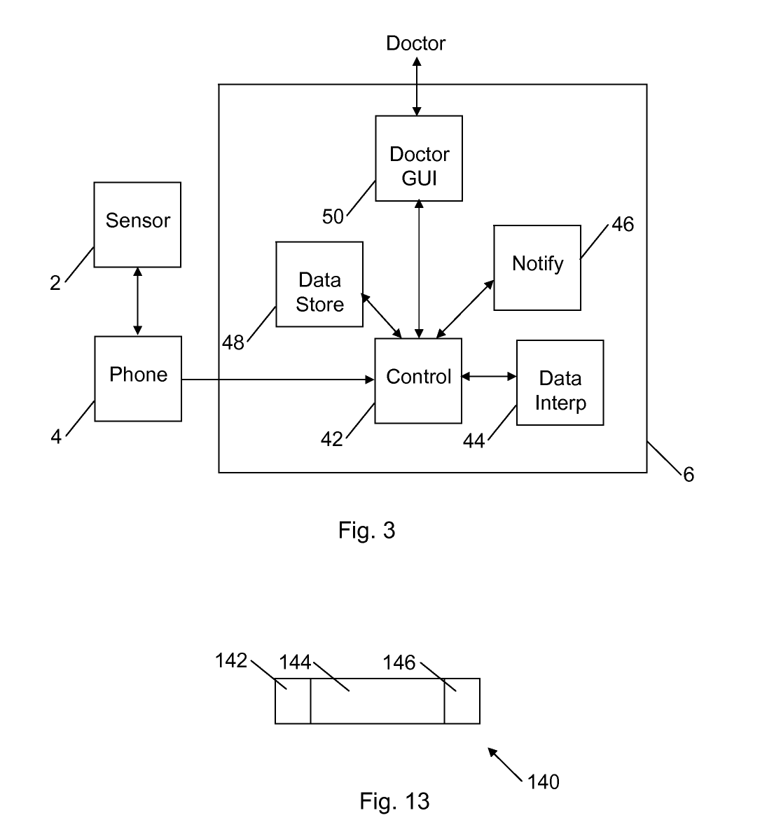

FIG. 3 is a block diagram showing further details of the system of FIG. 1;

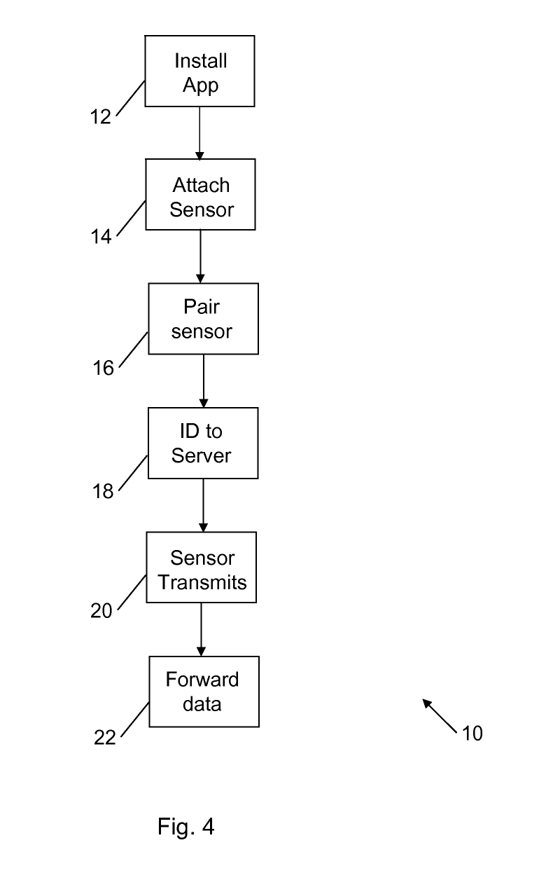

FIG. 4 is a flow chart showing an exemplary use of the system of FIG. 1;

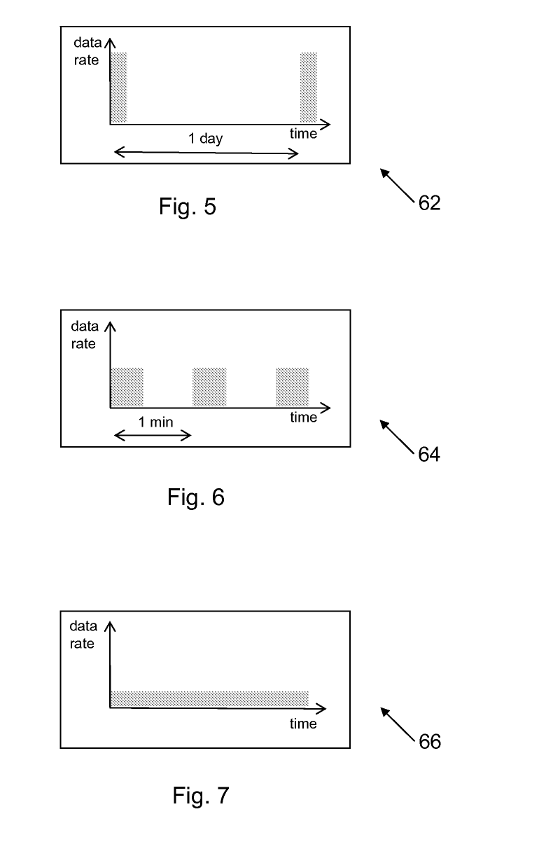

FIG. 5 shows a data upload arrangement in accordance with an aspect of the present invention;

FIG. 6 shows a data upload arrangement in accordance with a aspect of the present invention;

FIG. 7 shows a data upload arrangement in accordance with an aspect of the present invention;

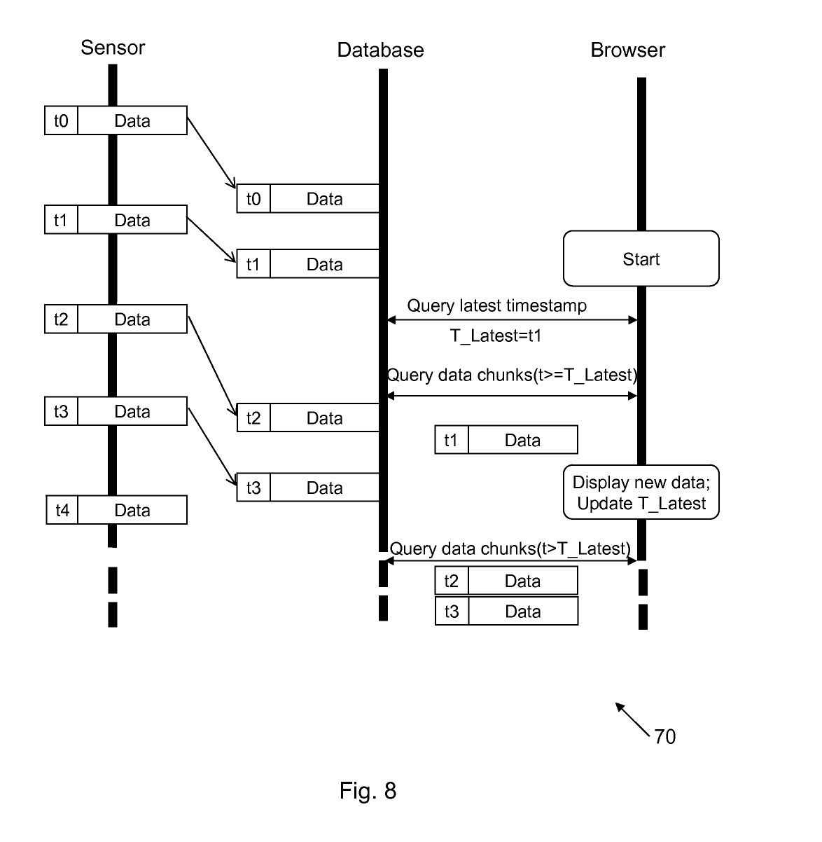

FIG. 8 is a message flow diagram in accordance with an aspect of the present invention;

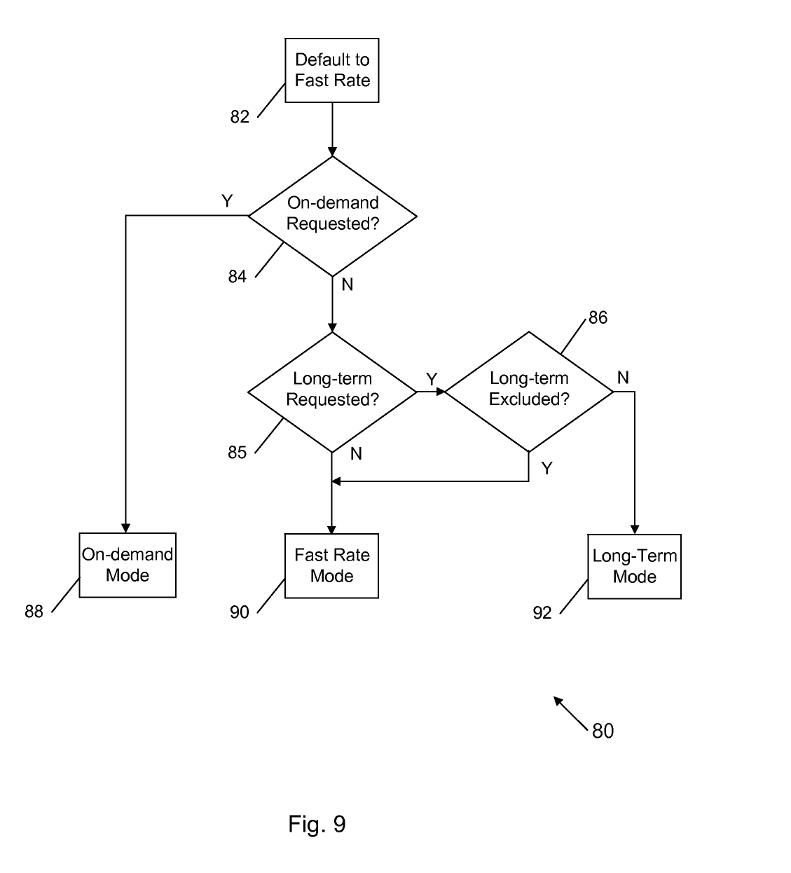

FIG. 9 is a flow chart showing an algorithm in accordance with an aspect of the present invention;

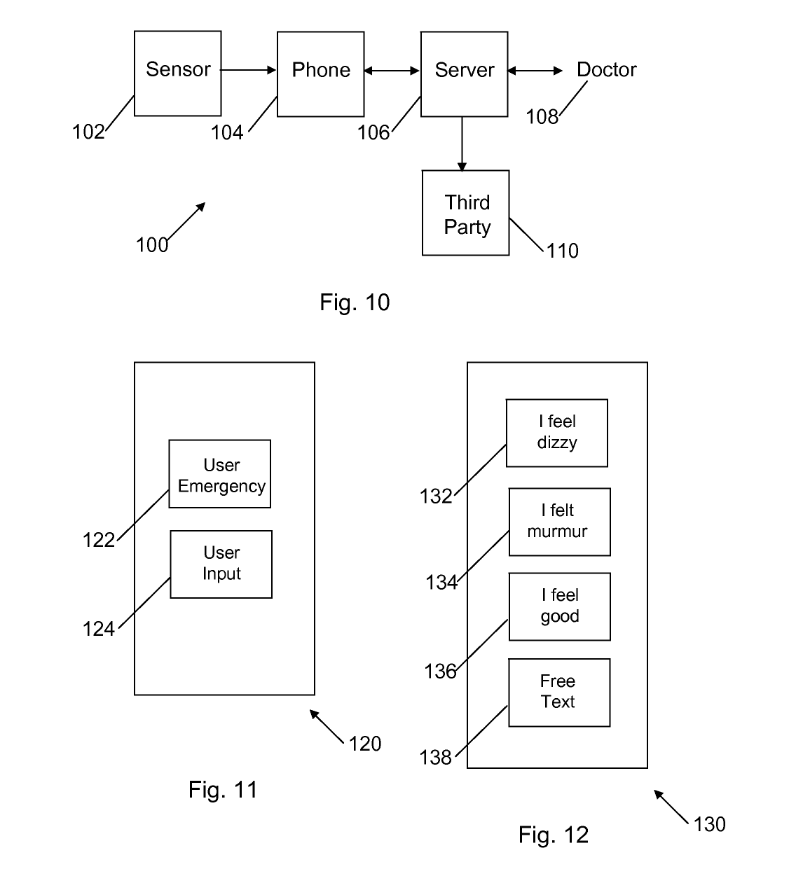

FIG. 10 is a block diagram of a system in accordance with an aspect of the present invention;

FIG. 11 shows a user interface in accordance with an aspect of the present invention;

FIG. 12 shows a user interface in accordance with an aspect of the present invention; and

FIG. 13 shows a data packet in accordance with an aspect of the present invention.

FIG. 1 is a block diagram of a system, indicated generally by the reference numeral 1, in accordance with an aspect of the present invention.

The system 1 comprises one or more medical sensors 2, a mobile communication device 4, and a server 6 and may additionally include a doctor 8. The sensor(s) 2 provide data to the mobile communication device 4. The device 4 is in two-way communication with the server 6 and so is able to upload data received from the sensor 2 to the server 6. The doctor 8 (when present in the system 1) is in two-way communication with the server 6 and can therefore access data uploaded to the server 6 by the mobile communication device 4.

The medical sensor 2 can take many different forms. Indeed, one of the advantages of the present invention is that the system is sufficiently flexible to allow any suitable sensor to be used. Exemplary sensors 2 include blood pressure sensors, blood sugar level sensors, blood oxygen level sensors, temperature sensors etc. The sensor may be invasive or non-invasive.

FIG. 2 is a further block diagram showing the sensor 2, mobile communication device 4 and server 6 of the system 1 and additionally showing further details of the mobile communication device 4. As shown in FIG. 2, the mobile communication device includes a controller 32 that receives data from the medical sensor 2 and is in two-way communication with the server 6. The device 4 also includes a graphical user interface (GUI) 34 and a buffer 36 that are each in two-way communication with the controller 32. The GUI 34 enables the user (i.e. the subject of the monitoring by the sensor 2) to interact with the mobile communication device 4.

The device 4 typically supports at least some of the following functionality: pairing with the sensor 2; reception of data from the sensor 2; display of data in a sliding window of the GUI 34; buffering (using the buffer 36) of measurement data with respect to the configurable data upload frequency; uploading of measurement data to the server 6; notifying the user if network connectivity is interrupted (WAN supervision), sensor connectivity is interrupted, in particular if the phone is not in proximity of the patient (PAN supervision), if the sensor device is not properly attached (lead-off detection) or if the sensor battery needs to be replaced or recharged; and notification to the user of results based on measurements taken by the sensor 2 (via the GUI 34). Many of these features are discussed further below.

FIG. 3 is a further block diagram showing the sensor 2, the mobile communication device 4 and the server 6 of the system 1 and additionally showing further details of the server 6. As shown in FIG. 3, the server 6 includes a controller 42, a data interpreter 44, a notification engine 46, a data store 48 and a graphical user interface (GUI) 50 for the doctor. The controller 42 is in two-way communication with the mobile communication device 4, the data interpreter 44, the notification engine 46, the data store 48 and the GUI 50. The doctor 8 interfaces with the server 6 via a two-way connection with the GUI 50.

In use, the mobile communication device 4 receives data from the medical sensor 2 and forwards that data (in a format discussed further below) to the controller 42 of the server 6. The controller 42 communicates with the data store 48 to store the data.

Data is sent from the controller 42 to the data interpreter 44 for analysis and results are returned to the controller 42. The results obtained from the data interpreter 42 are typically also stored in the data store 48. The doctor 8 uses the GUI 50 to access the data stored in the data store 48. Thus, the doctor can gain access to both the raw data received at the server 6 from the mobile communication device 2 and the results obtained from the data interpreter 44.

The data interpreter 44 can take many different forms dependent on the data (and health conditions) that are being monitored by the medical sensor 2.

In some cases, the controller 42 may determine that a user (e.g. the subject of the monitoring by the sensor 2 of the doctor 8) should be informed of an event (such as an anomaly detected by the data interpreter 44 or a problem noted by the doctor 8). In this case, the controller 42 communicates with a notification engine 46 and the engine provides a message for sending to the user (typically to the mobile communication device 4).

At least some of the elements of the server 6 may be provided remotely from the server. For example, the data interpreter 44 may be provided by a third party, with the server 6 sending data to the data interpreter and the data interpreter returning results to the controller 42 of the server 6. Similarly, data storage, such as the data store 48 may be provided remotely.

The GUI 50 for the doctor supports the following functions: secure login (by the doctor 8); management of patient data (Patient List Page); browsing through stored and interpreted patient data; filtering and grouping of events; and annotations to the patient data.

FIG. 4 is a flow chart, indicated generally by the reference numeral 10, showing an exemplary use of the system 1.

The algorithm 10 starts at step 12, where the patient installs the relevant application on his mobile communication device 4. Next, at step 14, the patient attaches the sensor 2 as required (dependent, of course, on the nature of the sensor).

The newly-attached sensor 2 needs to be paired with the mobile communication device 4 that the patient will use to upload data to the server 6. This is done in step 16 and need be done only once. Subsequently, the connection between the sensor 2 and the mobile communication device 4 is established automatically.

Next, at step 18, the patient logs into the server 6 using the application installed on his mobile communication device in step 12 above using credentials (username, password) as provided, for example, by the doctor 8.

At this stage, the sensor 2 is paired with the mobile communication device 4. Accordingly, at step 20, patient data is wirelessly transmitted from the sensor 2 to the mobile communication device 4. Next, at step 22, the data received at the mobile communication device 4 from the sensor 2 is transmitted to the server 6. Steps 20 and 22 are repeated for the duration of the measurement period.

Depending on the risk position of the patient and the actual medical need, the following sub-use cases (applications) are supported: very-long-term upload (non-real-time); fast response (near real-time); and on demand (real-time). The different upload arrangements are shown in FIGS. 5 to 7.

FIG. 5 is a graph, indicated generally by the reference numeral 62, showing the very-long-term upload arrangement referred to above. As shown in FIG. 5, data is uploaded once per day (although a different period could, of course, be chosen). By uploading data only once per day, the communication between the mobile communication device 4 and the server 6 is limited (thereby reducing communication costs and power usage in the mobile communication device). The very-long-term upload arrangement also requires the buffer 36 of the mobile communication device 4 to be used to store data provided by the sensor in between uploads to the server 6.

FIG. 6 is a graph, indicated generally by the reference numeral 64, showing the fast response arrangement referred to above. The fast-response arrangement has a much shorter upload period compared with the very-long term upload arrangement 62. As shown in FIG. 6, the upload period may be 1 minute, although, of course, other periods could be chosen. Continuous automatic data interpretation allows for fast response in case of a dangerous situation for the patient. This application requires more resources, in particular battery power from the mobile phone and a consistent network connection. During phases of network unavailability, the data will be stored at the buffer 36 of the mobile phone.

FIG. 7 is a graph, indicated generally by the reference numeral 66, showing the on-demand arrangement referred to above. The On-demand arrangement sends data continuously from the device 4 to the server 6 and supports remote diagnosis without a visit to the doctor.

FIG. 8 shows a message flow diagram, indicated generally by the reference numeral 70, in accordance with an aspect of the present invention. The message flow diagram 70 shows data at a sensor, data at a database (received from the sensor) and data at a browser (received from the database).

Each data chunk provided by the sensor includes a timestamp (t0, t1, t2 etc.) and a data portion. As shown in FIG. 8, the data chunks are provided with a regular time interval. The data chunks are, however, received at the database with differing time intervals, due, for example, to transmission delays. These delays cause potential problems to the display at the browser.

As shown in FIG. 8, the browser, when ready to display data, requests the most recently received timestamp (t1 in the exemplary message flow 70). In response, the browser requests all data having a timestamp of t1 or later (only the data portion t1 in this example).

When the browser is ready for further data, it increments the timestamp and asks for all data with a timestamp greater than t2. In this example, however, due to differing delays, two additional data chunks (with timestamps t2 and t3) are provided and can be displayed at the browser.

Accordingly, the browser can readily handle data that arrives at the database with differing delays.

The fast response arrangement provides regular data but is less expensive in terms of communications costs and power consumption in the mobile communication device 4 than the on-demand arrangement. The fast response arrangement may, for example, be used for patients that are considered at risk where near real-time monitoring is desired. The monitoring mode may, for example, be modifiable so that in the event of a potential anomaly being detected in the data received from the patient, the upload mode could be changed from the fast response mode to the on demand mode. Alternatively, in the event that the patient's condition improves to the extent that he is no longer considered to require active monitoring, the upload mode could be changed from the fast response mode to the very-long-term upload mode.

FIG. 9 is a flow chart showing an algorithm, indicated generally by the reference numeral 80, showing an example of how the data upload period may be set. The algorithm 80 is provided by way of example only; many alternatives could be provided.

The algorithm starts at step 82, where the fast-rate upload mode is set as a default upload mode. Next, at step 84, it is determined whether any input (e.g. an input from the patient, an input from a doctor, or an input from the data interpreter 44) requires that the upload mode be changed to the on-demand mode. This may be because a serious potential health problem has been identified, or because the patient is about to have a consultation with the doctor. If so, the algorithm terminates at step 88, where the upload mode is changed to the on-demand mode; otherwise, the algorithm moves to step 85.

At step 85, it is determined whether any of the inputs has requested the long-term upload mode. If so, the algorithm moves to step 86; otherwise the algorithm terminates at step 90, where the default fast-rate mode is maintained.

At step 86, it is determined whether any of the inputs excludes the use of the long-term mode. For example, a doctor may exclude the use of the long-term mode where this might be inappropriate for the medical needs of a particular patient. If the use of the long-term mode has been excluded, the algorithm terminates at step 90, where the default fast-rate mode is maintained. If the use of the long-term mode has not been excluded, the algorithm terminates at step 92, where the long-term upload mode is used.

FIG. 10 is a block diagram of a system, indicated generally by the reference numeral 100, in accordance with an aspect of the present invention. The system 100 comprises a sensor 102, a mobile communication device 104 and a server 106 that are similar to the sensor 2, mobile communication device 4 and server 6 described above with reference to FIG. 1.

The system 100 optionally includes a doctor 108 and, as in the system 1, the doctor may be informed of problems identified in the medical data and may be able to provide inputs to the system 100.

The system 100 additionally includes a third party 110. As described above, the controller 42 of the server 6 (which corresponds to the server 106) may use the notification engine 46 to send alerts to the patient. The system 100 differs from the system 1 by additionally enabling the controller 42 to use the notification engine to provide alerts to the third party 110.

The third party 110 may, for example, be a caregiver, a paramedic or a relative as identified by the patient. The third party contacted may be selected by the server 66 on the basis of the location of the patient. This location data can be readily obtained by determining the location of the mobile communication device 64 in a manner well known in the art. By way of example, if the patient is deemed by the server 66 to be at home, then the server may contact a neighbour with alert data. If the patient is deemed to be at work, then the server may contact a work colleague. In any event, if an alert is sufficiently serious to warrant contacting a paramedic, then the paramedic can be provided with location data based on the location of the mobile communication device 64 that is providing data to the server 66. Of course, any other third party to whom an alert is sent could be provided with location data.

FIG. 11 shows a user interface, indicated generally by the reference numeral 120, in accordance with an aspect of the present invention.

The user interface 120 includes a “user emergency” button enabling the user of the mobile communication device 4 (i.e. the person being monitored by the sensor) to indicate an emergency event. The provision of a single button enables an emergency event (such as a heart attack) to be indicated by the user with the minimum of effort, delay and concentration. The indication of an emergency event may result in an alert being provided to a doctor and/or to a third party (such as an emergency contact or a paramedic). The emergency alert may provide location data relating to the user to the doctor, paramedic and/or emergency contact.

The user interface 120 also includes a “user input” button 124. The user input button is used to allow the user to provide information outside of emergency situations (when the user has more time to interact with the user interface 120). Pressing the user input button 124 takes the user to the user interface 130 shown in FIG. 12.

The user interface 130 includes an “I feel dizzy” button 132, an “I felt murmur” button 134, an “I feel good” button 136 and a “Free text” button 138. Pressing any of the buttons 132, 134 or 136 results in the corresponding data being input to the data stream sent to the server 6. Pressing the button 138 enables the user to enter any text that they wish.

Of course, more or different options to those shown in FIG. 12 could readily be provided.

The user interfaces 120 and 130 are provided by way of example only. The skilled person will be aware of many alternative mechanisms that would also the user to provide such data to the server 6.

FIG. 13 shows a data structure, indicated generally by the reference numeral 140, in accordance with an aspect of the present invention. The data structure 140 comprises a timestamp 142, a first data portion 144 and a second data portion 146. The first data portion 144 includes data provided by the medical sensor 2. The second data portion 146 includes user event data as input using the user interface 120 or the user interface 130. The second data portion 146 may be empty if the user has not provided any input.

The data structure 140 enables user input, such as “I feel dizzy” to be matched with the medical data being generated at the time. This enables a doctor to review the data and to make a more complete analysis that might have been possible based on the medical data alone.

The systems 1 and 100 provide solutions for both individuals and doctors, built upon low-cost medical sensors that are connected to the network via the mobile phone of the user and a Cloud based server architecture. Users have full mobility and medical conditions may be continually monitored with near “real time” feedback from an analytical engine being provided, if required. The solution supports continual recording, storage and processing of information for doctors. It automatically alerts the patient, first responders, doctors or caregivers of any major event.

Two exemplary use cases of the systems 1 and 100 are described below.

The first use case is intended largely for use by doctors. Medical data is recorded by the system and the doctor can access the recorded data using the GUI 50 described above. In addition, the data interpreter 44 can alert the doctor in the event that potential problems are detected.

The second use case is intended largely for use by individuals. The system 1 supports self-monitoring by the user (preventive care). This is facilitated by the data interpreter 44 running autonomously on the server 6. The server 6 notifies the user instantly if anomalies exceed a certain threshold and the user should visit the doctor. In case of danger to life the system 1 may also alert the emergency services and other caregivers (e.g. relatives or neighbors) nominated by the user. The user may provide his doctor access to his data.

As described above, the invention provides a simple low-cost medical sensor connected to a server (typically cloud based) via a mobile network with a mobile phone acting as a gateway.

The remote software can analyse the data. Raw data, and analysed results, are stored in bulk remote from the sensor (e.g. in the cloud). The doctor has access to this data without requiring the patient to be present (and has access to data generated after the patient's last visit to the doctor).

The basic system architecture involves a sensor device, a mobile phone and a server. The sensor device is typically an “off-the-shelf” device, such as a digital plaster. The sensor communicates with a paired mobile phone in a very simple and well-established manner. The mobile phone has the relevant software installed. Data is received from the sensor and sent to the server; data buffering may be required (e.g. if connection to the server is lost). A data display (to the user) may be provided, but this is not essential. User notification (e.g. of alerts) may be provided. The server may require secure login and may have the bulk data storage and the main data processing capability of the system. The server typically provides the data interpretation, performs data plotting and issues alerts (if such a feature is provided by the system). The server may need to interface with multiple users (e.g. the patient, doctors, paramedics, relatives, emergency contacts).

Advantages of the invention include the following. Each part of the system can be optimized. The sensor can be as simple as possible (just provides data—no need for data processing); thus the sensor can be cheap and battery usage minimized. The communication system is optimized by allowing mobile phone operators to do all the work (e.g. redundancy by providing multiple communication methods). The storage in the cloud is cheap. The centralized software (rather than providing software to the phones) is cheaper, simpler and easier to update. The system enables long observations times that provide a clear medical advantage. The system is universal and scalable. The system is also flexible, allowing new applications/modified applications to be provided (e.g. by others) as required. Doctors have access to bulk data stored at the server regardless of whether the patient is present. Paramedics can also potentially access bulk data (e.g. via a similar GUI to that available to a doctor).

The principles of the present invention can be applied to monitoring a wide range of medical conditions. Examples include monitoring blood pressure, blood sugar level, blood oxygen level, temperature and heart rate. The combination of such variables may also be measured. The skilled person will be aware of many other uses of medical sensors in accordance with the principles of the present invention.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A mobile communication device; comprising:
a first input configured to receive medical data of a user of the mobile communication device; and
a first output configured to provide said medical data to a server via a mobile communications link.

2. A mobile communication device as claimed in claim 1, wherein said first output is configured to periodically provide said medical data to the server via the mobile communications link, and wherein a time period between successive provisions of medical data to said server is variable.

3. A mobile communication device as claimed in claim 2, further comprising a second input for receiving an indication from the server of a desired period between successive provisions of medical data to said server.

4. A mobile communication device as claimed in claim 3, further comprising a third input for receiving an indication from the user of a desired period between successive provisions of medical data to said server.

5. A mobile communication device as claimed in claim 4, further comprising:
a fourth input configured to receive additional data from said user; and
a second output configured to provide said medical data and said additional data to the server via the mobile communications link.

6. A mobile communication device as claimed in claim 5, further comprising a user interface to enable the user to provide said additional data.

7. A mobile communication device as claimed in claim 5, further comprising an emergency input to enable the user to use the additional data to indicate an emergency event.

8. A mobile communication device as claimed in claim 5, wherein the medical data and the additional data are stored with timestamp data such that the time of generation of the medical data can be compared with the time of generation of the additional data.

9. An apparatus, comprising:
a first input configured to receive medical data from a mobile communication device via a mobile communications link, wherein the medical data relates to a user of said mobile communication device; and
a processor for processing said medical data.

10. An apparatus as claimed in claim 9, further comprising a first output for indicating to the mobile communication device a desired period between successive provisions of the medical data.

11. An apparatus as claimed in claim 10, further comprising a second input for indicating a desired period between successive provisions of the medical data.

12. An apparatus as claimed in claim 9, further comprising a second output configured to provide an alert in the event that one of a number of defined anomalies are detected in said medical data.

13. An apparatus as claimed in claim 12, wherein the alert is provided to the said user.

14. An apparatus as claimed in claim 12, wherein the alert is provided to a second user.

15. A method, comprising:
receiving medical data of a user at a first input of a mobile communication device; and
providing said medical data from the mobile communication device to a server via a mobile communications link.

16. A method as claimed in claim 15, wherein a time period between successive provisions of medical data to said server is variable.

17. A method as claimed in claim 15, further comprising:
receiving additional data from said user at a second input of the mobile communication device; and
providing said medical data and said additional data to a server via the mobile communications link.

18. A method as claimed in claim 17, wherein the medical data and the additional data are stored with timestamp data such that the time of generation of the medical data can be compared with the time of generation of the additional data.

19. A method, comprising:
receiving medical data from a mobile communication device via a mobile communication link, wherein the medical data relates to a user of said mobile communication device; and
processing said medical data.

20. A method as claimed in claim 19, further comprising indicating, to the mobile communication device, a desired time period between successive provisions of medical data.

21. A method as claimed in claim 20, further comprising receiving an indication of the desired period between successive provisions of the medical data.

22. A method as claimed in claim 19, further comprising providing an alert in the event that one of a number of defined anomalies are detected in said medical data.

23. A computer program product comprising computer readable executable code, when run on a processor, controls said processor to perform a method comprising:
receiving medical data of a user at a first input of a mobile communication device; and
providing said medical data from the mobile communication device to a server via a mobile communications link.

24. A computer program product comprising computer readable executable code, when run on a processor, controls said processor to perform a method comprising:
receiving medical data from a mobile communication device via a mobile communication link, wherein the medical data relates to a user of said mobile communication device; and
processing said medical data.
